(19) United States
(12) Patent Application Publication
(10) Pub. No.: US 2004/0212710 A1
(43) Pub. Date: Oct. 28, 2004

(54) Driving a memory display in an image memory card

(75) Inventors: John R. Fredlund, Rochester, NY (US); Raymond E. Wess, Holley, NY (US); Joseph A. Manico, Rochester, NY (US)

Correspondence Address: Pamela R. Crocker, Patent Legal Staff, Eastman Kodak Company, 343 State Street, Rochester, NY, 14650-2201, US

(73) Assignee: Eastman Kodak Company

(21) Appl. No.: 10/851,449

(22) Filed: May 21, 2004

Related U.S. Application Data
(63) Continuation-in-part of application No. 09/597,134, filed on Jun. 20, 2000, now Pat. No. 6,724,427.

(51) Int. Cl. H04N 5/222

(52) U.S. Cl. 348/333.01

(57) ABSTRACT

A removable data bearing medium having a display which displays images in response to applied voltage and a data containing memory, including an structure for coupling the memory to a first source of voltage for retrievably storing data files; and a structure disposed in the removable image bearing medium for selectively coupling a voltages to the image bearing medium from a second source of voltage, the image bearing medium including material which is effective in a first condition in response to a selectively applied first voltage for displaying an image and effective in a second condition in response to a second voltage lower than the first voltage to prevent the display of an image, the material being selected so that after displaying the image such material continues to display the image after the removal of the applied voltages from the second source of voltage.

### CROSS REFERENCE TO RELATED APPLICATION

This application is a continuation-in-part of U.S. patent application Ser. No. 09/597,134 filed Jun. 20, 2000, now U.S. Pat. No. 6,724,427 issued Apr. 20, 2004, entitled “Driving A Memory Display In An Image Memory Card” by John R. Fredlund et al, the disclosure of which is incorporated herein.

### FIELD OF THE INVENTION

The present invention relates to cameras having removable image bearing media.

### BACKGROUND OF THE INVENTION

Current silver halide film cameras have displays for indicating settings and status conditions, such as frame number, of the camera. Often, the display uses twisted nematic liquid crystals that that requires continuous electrical drive to display information. Cameras with this type of display can be turned on only for short periods of time to preserve battery life. When the cameras are turned off, the liquid crystal display goes blank. An operator must turn on the camera to determine the status of the camera. These cameras typically incorporate a high voltage supply to drive an electronic flash built into the camera, and utilize cartridges that contain the film in a light tight environment.

Many digital cameras use liquid crystal displays to display a captured image. Displays in these cameras are also nematic liquid crystals displays that can drain an electronic camera high voltage supply in a short period of time.

Many digital cameras also use removable memory cards to store images. There is no way to tell how much capacity remains or what images reside on these memory cards.

### SUMMARY OF THE INVENTION

Accordingly, it is an object of the present invention to provide a display on image bearing medium.

It is another object of the present invention to provide a display on image bearing medium that presents an image to a viewer even when the voltage to the display is removed.

These objects are achieved in a removable data bearing medium having a display which displays images in response to applied voltage and a data containing memory, comprising:

(a) means for coupling the memory to a first source of voltage for retrievably storing data files; and

(b) means disposed in the removable image bearing medium for selectively coupling a voltages to the image bearing medium from a second source of voltage, the image bearing medium including material which is effective in a first condition in response to a selectively applied first voltage for displaying an image and effective in a second condition in response to a second voltage lower than the first voltage to prevent the display of an image, the material being selected so that after displaying the image such material continues to display the image after the removal of the applied voltages from the second source of voltage.

An advantage of the present invention is that it permits the use of displays which require a high voltage source to display images.

A feature of the present invention is that the high voltage supply in the electronic flash unit can be used as a source of high voltage for the display on the image bearing medium.

It is a feature of the present invention it permits display of images on the image bearing medium when high voltage to the display is turned off.

It is a further feature of the present invention to provide an indication on the image bearing medium of the storage capacity remaining.

### BRIEF DESCRIPTION OF THE DRAWINGS

FIG. 1 is a top sectional view of a silver halide camera with a film cartridge with a memory display;

FIG. 2 is a top sectional view of an electronic capture camera with a removable memory card with a memory display;

FIG. 3 is a side sectional view of the memory display of FIG. 1;

FIG. 4 is a top view of the memory display of FIG. 3;

FIG. 5 shows an electrical circuit which drives the display of FIG. 3 by selectively coupling the flash unit high voltage supply to the display;

FIG. 6A is a partial top view of the memory display of the electronic capture camera of FIG. 2;

FIG. 6B is a magnified view of the memory display of FIG. 6A;

FIG. 7 is an electrical schematic circuit which drives the memory display of FIGS. 6A and 6B;

FIG. 8A is a waveform to drives a memory material to a reflecting, or bright condition;

FIG. 8B is a waveform to drives a memory material to a transmitting, or dark condition;

FIG. 8C is a waveform to drive a memory material to an intermediate condition between transmission and reflection;

FIG. 9 is a view of a memory card with a memory display;

FIG. 10 is a cross-sectional view of the memory card of FIG. 9;

FIG. 11 shows an exploded view of a memory card in accordance with the invention;

FIG. 12 shows user information on the display of a memory card in accordance with the invention;

FIG. 13 is a memory card reader/writer attached to a computer; and

FIG. 14 is a memory card with display with retail information.

### DETAILED DESCRIPTION OF THE INVENTION

A top sectional view of a silver halide film camera 10 is shown in FIG. 1. A film cassette 20 with a memory display 37 in camera 10 holds a strip of film 22 that captures images from optic 26. Film 22 is sequentially taken up onto take-up spool 24 to capture a set of images. After image exposure is complete, film 22 is returned to film cassette 20. Camera controller 30 receives commands from an operator and controls the sequential motion of film 22 and optic 26. Camera controller 30 can provide supplemental illumination to a scene by discharging a high voltage pulse through flash tube 42 in a flash unit. Flash tube 42 requires a flash capacitor 40 to store energy for flash tube 42. Flash capacitor 40 typically stores energy in a capacitor having over 50 micro-farads capacitance at over 100 volts.

The status of camera 10 is shown on a display 35 in camera 10. Typically, display 35 shows the number of the current frame of film, the operational mode of flash tube 42, and operating parameters of optic 26. In more complex cameras, display 35 is a conventional nematic liquid crystal display. Nematic liquid crystal fluids act in conjunction with polarizing filters to act as a shutter to reflect or transmit light. Transmitted light is selectively reflected from a surface behind the display to provide light indicia. The reflected light provides a white indicia. When light is blocked by the polarizing filters, the imager area is dark. Nematic liquid crystals must have a continuous electrical field across the display to display information.

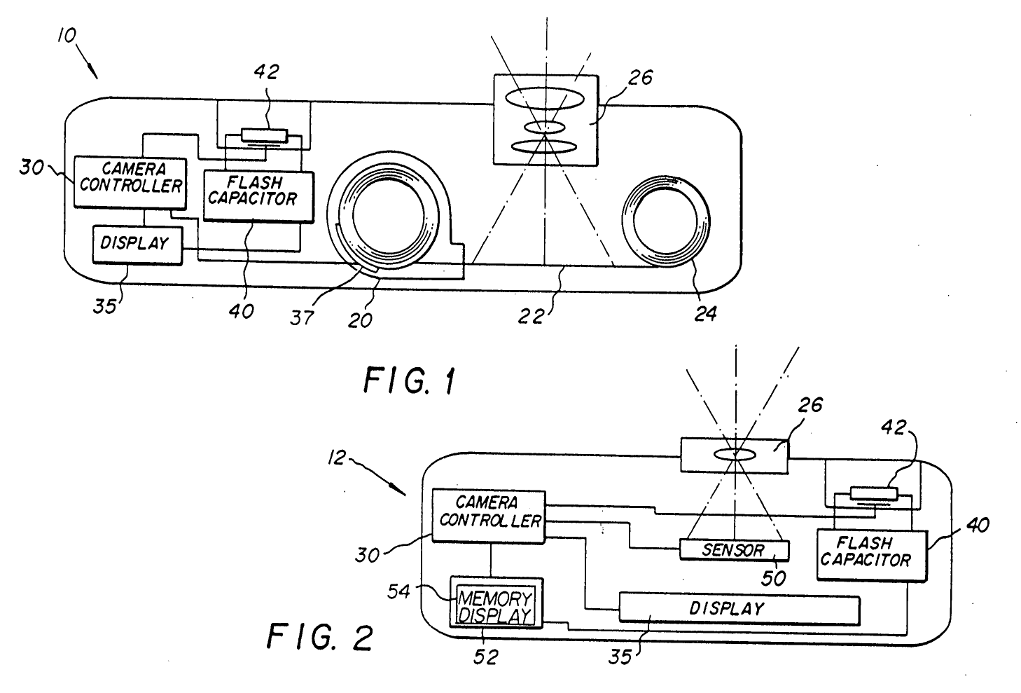

FIG. 2 is a top sectional view of an electronic camera 12. Many of the components operate as in conventional camera 10. Film 22 is replaced by electronic sensor 50. Electronic sensor 50 captures a scene and camera controller 30 stores captured image data in removable memory card 52 with memory display 54 by applying a first source of voltage to the data memory in memory card 52. Display 35 in electronic camera 12 displays the status of electronic camera 12, and in certain cases displays images from memory card 52. The flash tube 42 is often provided in electronic camera 12 to supply additional light to a scene at the time of image capture. Flash tube 42 requires the flash capacitor 40 to store energy for flash tube 42. Flash capacitor 40 typically stores energy in a capacitor having over 50 micro-farads capacitance at over 100 volts.

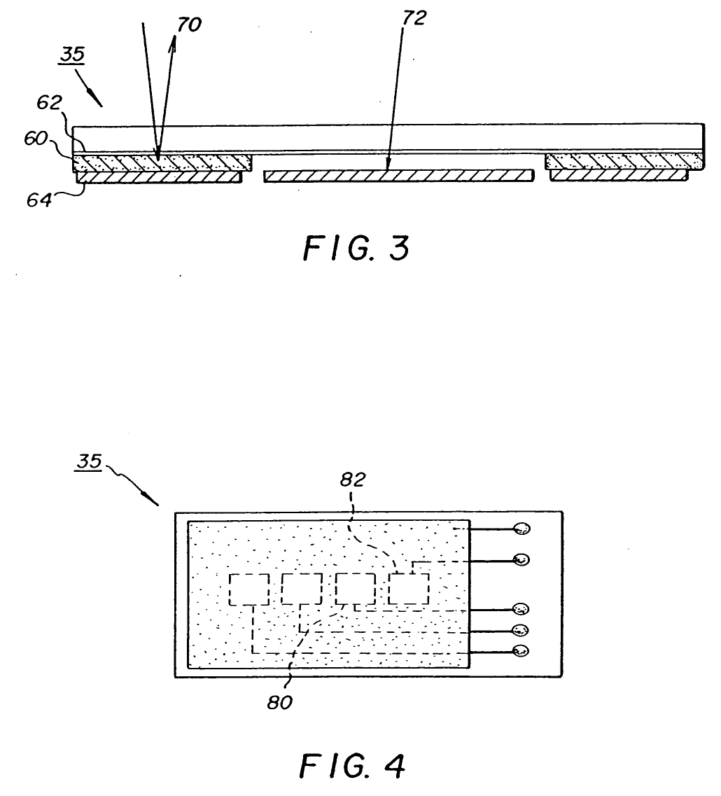

FIG. 3 is a diagram of display 35 in accordance with the present invention. Memory material 60 is disposed between a transparent top conductor 62 and a bottom conductor 64. Bottom conductor 64 can be a transparent electrical conductor such as Indium-Tin-Oxide or a light absorbing conductor formed by an oxide of a metal such as platinum or nickel. Memory material 60 can be a chiral doped nematic liquid crystal such as those disclosed in U.S. Pat. No. 5,695,682. Applied fields of various intensity and duration change the condition of chiral doped nematic materials from a reflective to a transmissive condition. These materials have the advantage of maintaining a given condition indefinitely after the field is removed. Ambient light striking memory material can be reflected light 70, providing a “light” image or can become absorbed light 72 which provides a “dark” image. The light modulation is effective in two conditions, which will be described in more detail below. Cholesteric liquid crystal materials can be Merck BL112, BL118 or BL126 which are available from EM Industries of Hawthorne, N.Y. In one experiment, two glass plates were coated with transparent Indium-Tin-Oxide (ITO) to form transparent top conductor 62 and bottom conductor 64. A laser beam was used to pattern the ITO coatings and 4 micron spacer beads were applied to one of the plates. The two plates were bonded together, with the spacer beads providing a 4 micron gap between the two plates. Black paint was applied to the back of the display over bottom conductor 64 to absorb light passing through memory material 60. The gap between the plates was filled with E. M. Industries (Hawthorne, N.Y.) chiral nematic fluid BL126 to act as memory material 60. A 3 millisecond pulse at 100 volts across areas on transparent top conductor 62 and bottom conductor 64 would convert the BL126 memory material 60 to a reflective “bright” areas. A 3 millisecond pulse at 40 volts would clear memory material 60 so that incident light was absorbed by the black paint and create “dark” areas. Such a display can be used to display camera status on memory display 37 for conventional camera 10 or display 54 for electronic camera 12. The memory display 37 includes the memory material 60 which is selected to be effective in a first condition for changing the state of the memory material 60 to display an image and effective in a second condition for preventing the display of the image. The memory material 60 is selected so that after displaying the image the memory material 60 continues to display the image after the removal of the applied high voltage. As will be seen shortly when a voltage less than the high voltage is applied to the memory material 60, the memory material 60 is caused to be in its second condition.

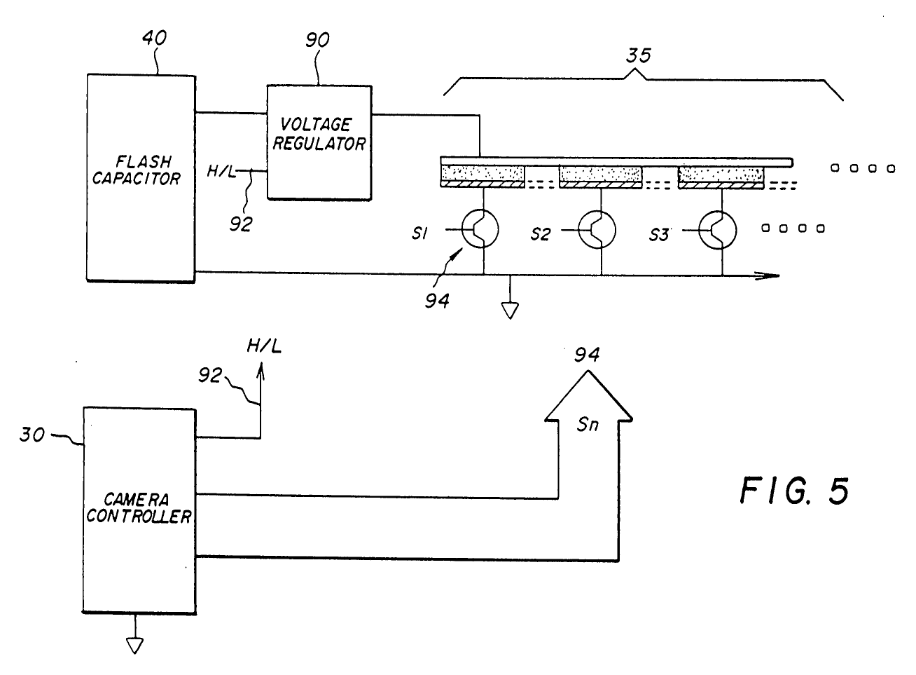

FIG. 4 shows such display 35 having memory material 60. A reflecting segment 80 has had a 100 volt pulse applied to memory material 60. A transparent segment 82 has received a 40 volt pulse. Transparent segment 82 passes incident light to a light absorbing surface to create a dark. The individual segments retain a given condition indefinitely after being pulsed. A camera with an electronic flash charging unit provides the source of high voltage. As will be discussed in FIG. 5 a camera 10 or 12 with an electronic flash charging unit provides the source of high voltage that can be shut off and the image-bearing medium will continue to have an visible display.

FIG. 5 is a schematic for driving memory display 37 in conventional camera 10. Flash capacitor 40 is used as a source of high voltage for pulsing memory display 37. Flash capacitor 40 stores power at well over 100 volts. Voltage regulator 90 converts a voltage from flash capacitor 40 to either a high or low voltage. In one case, voltage regulator 90 is resistor network that changes 330 volts on flash capacitor 40 to either 100 or 40 volts in response to high-low voltage select line 92 which is used by camera controller 30 to select a pulse voltage for memory display 37. Using the pre-existing high voltage on flash capacitor 40 eliminates the need for an additional high voltage generating system in conventional camera 10.

Camera controller 30 uses high-low voltage select line 92 to changes the voltage applied to memory display 37. Memory display 37 contains chiral nematic liquid crystal memory material 60 to hold either a reflective or transmissive condition for each segment of display 37.

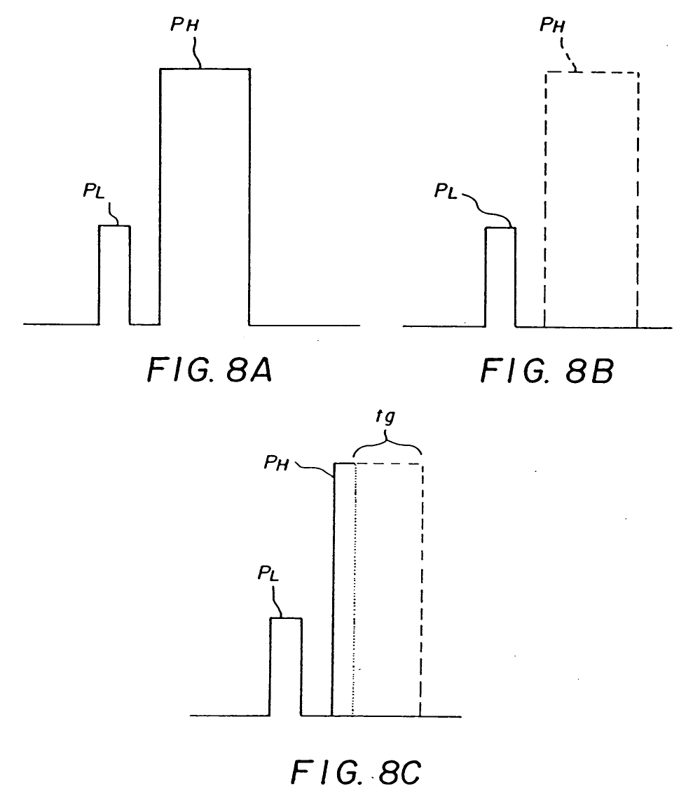

FIG. 8A show the voltage forms applied by camera controller 30 to a segment of memory display 37 to write the segment into the reflective mode. Camera controller 30 sets voltage regulator 90 to a low voltage and pulses all segment switches 94 to clear all the segments with low voltage pulse P_{L}. Voltage regulator 90 is then set to a high voltage, and selected ones of segment drivers 94 are pulsed with a high voltage pulse P_{H} to convert those segments to the reflective mode.

FIG. 8B is waveform across a segment that has been kept in the transmissive mode. Because P_{H} was not applied across that segment, the segment remains in a transmissive, dark condition from P_{L}. After the write pulses P_{L} and P_{H} are applied, memory display 37 will continue to display status information indefinitely without the use of additional power. Conventional camera 10 can be de-energized and memory display 37 will continue to display information such as the number of images left on film 22 or dates of exposure of frames on film 22 or other information pertinent to images on film 22. If film camera 10 was a hybrid camera with the capacity to capture electronic images as well as film images, a representation of the at least one image electronically captured could also be displayed on memory display 37 on film cassette 20.

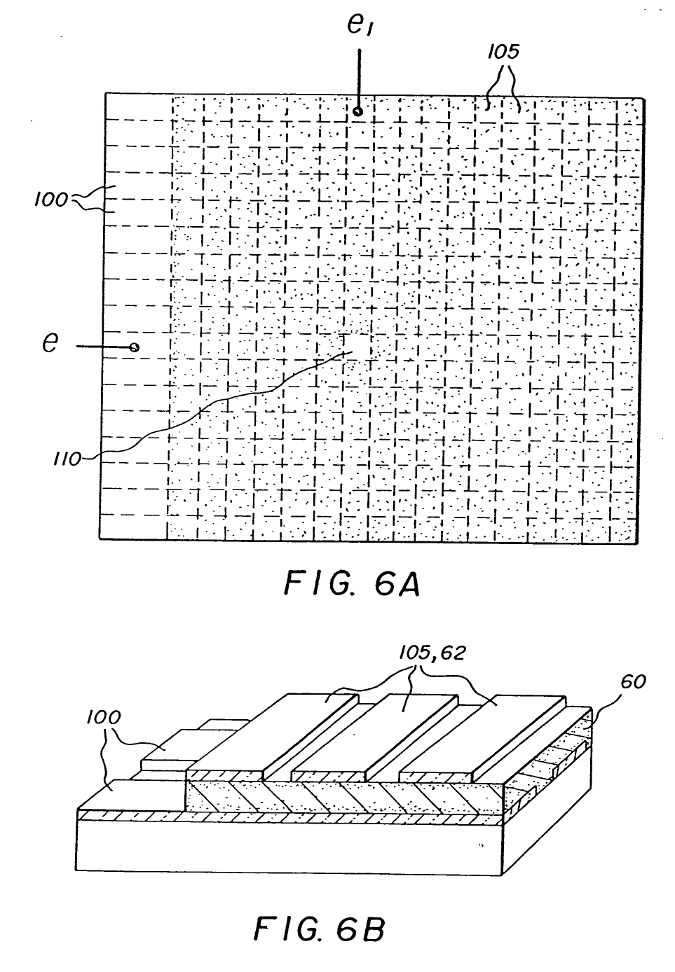

FIG. 6A is a partial top view and FIG. 6B is a magnified view of display 35 in electronic capture camera 12. A substrate 61 supports a plurality of transparent row traces 100. A second set of transparent traces form column traces 105. These traces provide for electrical conduction to the display 35 and coupled selectively the high voltage in the flash unit and the low voltage to the display as discussed above. The memory material 60 is disposed between row traces 100 and column traces 105. Memory material 60 is a chiral nematic material that can be written into either a reflective or transmissive condition. Chiral nematic materials can be tuned to red green and blue wavelengths of reflection and three color planes can be stacked to create a full color display.

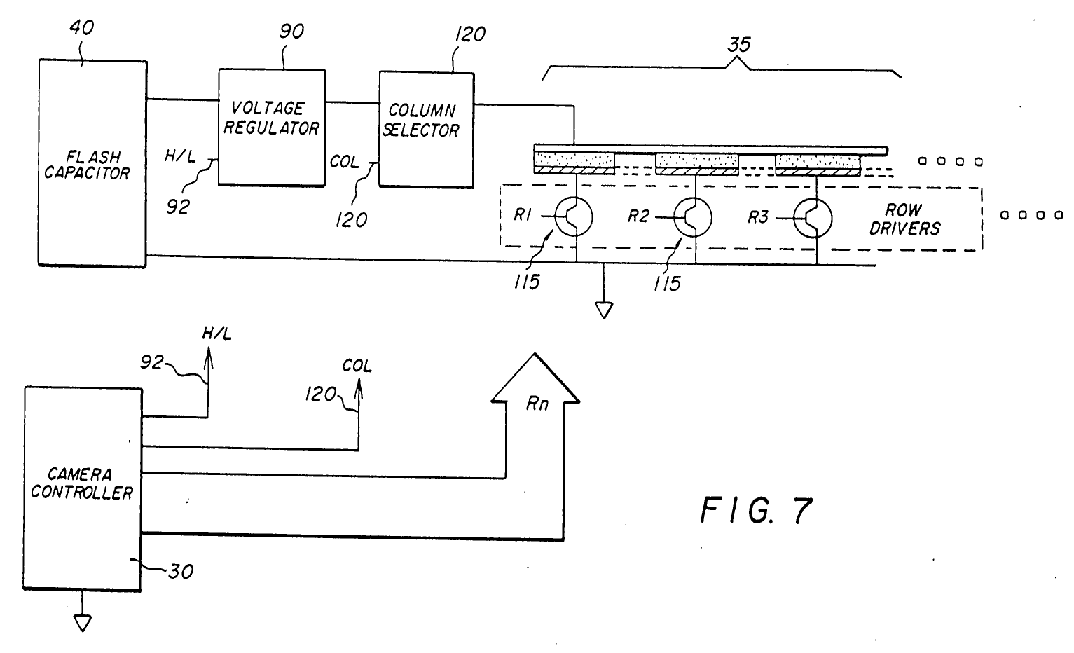

FIG. 7 is a schematic for driving display 54 in an electronic camera 12. Flash capacitor 40 is used as a source of high voltage for pulses to display 35. Flash capacitor 40 stores power at well over 100 volts. Voltage regulator 90 converts a voltage from flash capacitor 40 to either a first high or second low voltage. In one case, voltage regulator 90 is resistor network that changes 330 volts on flash capacitor 40 to either 100 or 40 volts in response to high-low voltage select line 92. Using the pre-existing second source of voltage on flash capacitor 40 eliminates the need for a high voltage generating system in electronic camera 12.

FIG. 8C is the drive signals applied across a single color plane of display 35 when used as to display a color, gray scale image stored in memory 52 using the electrical drive of FIG. 7. Camera controller 30 selects a first column using column selector 120. Camera controller 30 sets voltage regulator 90 to a low voltage, and row drivers 115 write a first clearing pulse P_{L} to all pixels in the row. Camera controller 30 then sets voltage regulator 90 to a high voltage. Row drivers 115 are energized for various gray level times tg. A chiral nematic material changes condition from the transmissive to the reflective condition progressively over time. By selecting an appropriate drive time tg for each pixel 110, a column of pixels can be written to various degrees of reflection, creating a column of pixels written to various gray levels. Camera controller 30 uses to column selector 120 to select the next column of pixels for writing. The process is repeated for each column, and each color plane to create a full-color, gray scale image on display 35. Other driving schemes can be used such as one proposed by Hashimoto et al, “Reflective Color Display Using Cholesteric Liquid Crystals”, SID 98 Digest, Article 31.1, 1998, pp. 897-900. Note that no extraneous light or significant heat that would interfere with camera operation is generated in writing to display 30.

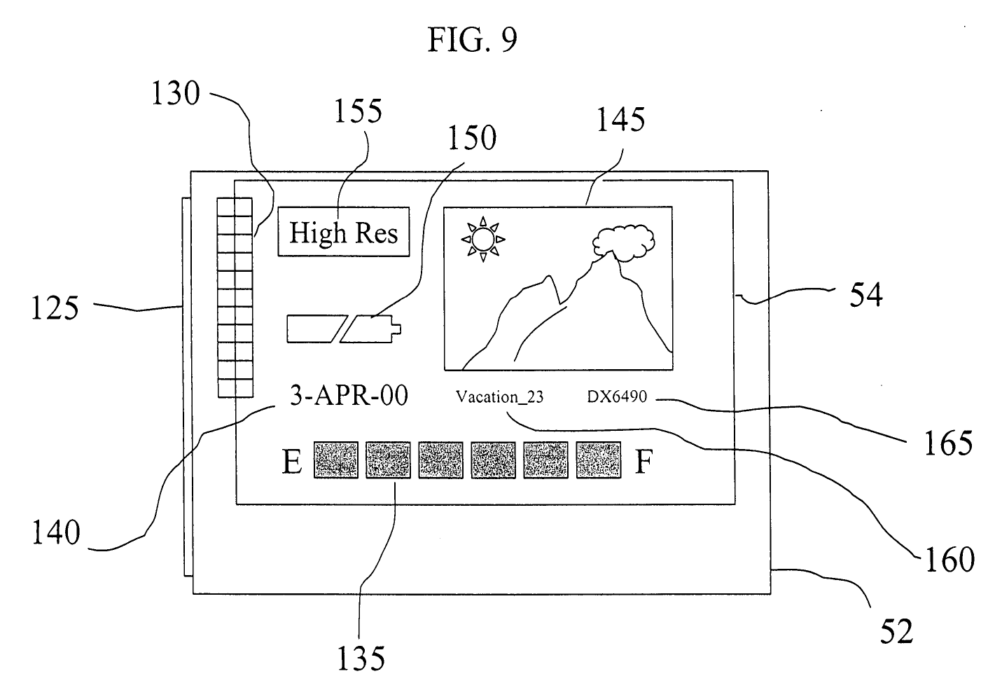

FIG. 9 is a view of a memory card 52 with a memory display 54. Connector 125 mates with the electronic camera 12 to transfer image data for storage as is traditional in electronic cameras. Connector 130 is provided so that the high voltages necessary to update memory display 54 can be applied. One skilled in the art will understand that it is also be possible to update both the memory card and the memory display using a single connector. In the embodiment shown, connector 130 is separated from connector 125 so that potentially damaging high voltages necessary for changing the state of memory display 54 are not accidentally applied to circuitry connected to connector 125. Connector 130 can be separated from connector 125 by various means that allows them to be located substantially in the same area such as on different sides of a connector array or on the same connector array separated by an insulated section. Camera 12, designed to utilize memory card 52 with display 54, applies a first voltage source to connector 125 and a second voltage source to connector 130.

Bar indicator 135 is a display that indicates the remaining storage space on the memory card. Time or date display 140 is an indication of the date of capture of at least one of the images stored on the card. Image display area 145 is a representation of at least one image file stored on the card. Image display area 145 can be imagettes of many image files stored on the card, or could be a portion of one image. Filename display 160 shows the filename of the image displayed on image display area 145. Camera type display 165 shows the camera used to capture the image on image display area 145.

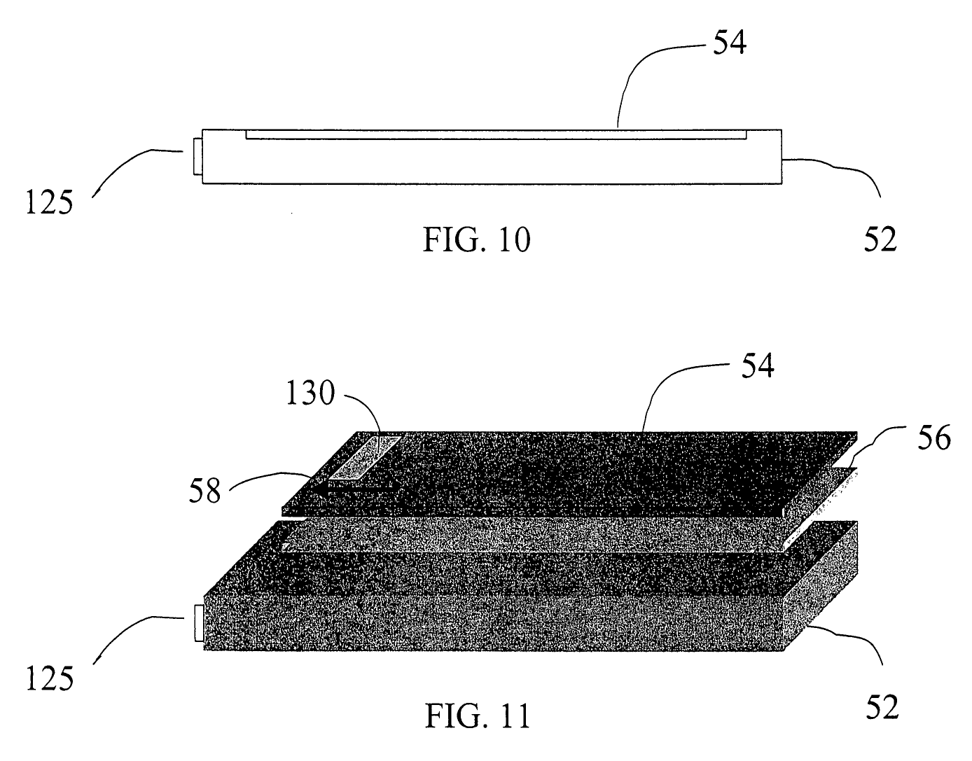

FIG. 10 shows a cross-sectional view of memory card 52 with a memory display 54. The profile of the card is not altered by memory display 54. Memory card 52 has been created with a recess to accept memory display 54 so as not to interfere with insertion of into a camera or memory card reader.

If memory display 54 is very thin in relation to the thickness of memory card 52, an version of memory display 54 can be provided that will attach to an existing memory card without interfering with insertion into camera 12 or memory card reader/writer 200.

FIG. 11 shows an exploded view of memory card 52 with memory display 54 positioned for attachment to memory card 52. Adhesive 56 will affix memory display 54 to memory card 52. Positioning tolerances must be maintained so that proper mating occurs between memory display 54 and the device into which memory card 52 is inserted. To that end, memory display 54 can be designed with a self locating feature or features such as being sized in a manner where the edges of memory display 54 are of the same dimensions as memory card 52. Additionally, memory display 54 can have a marking 58 to insure proper orientation, or application can be assisted by a fixture such as a positioning jig (not shown). Self locating feature 59 can be provided to assist proper placement of memory display 54 on memory card 52. Self locating feature 59 is shown as a pair of flaps on memory display 54 used to locate the corner of memory card 52.

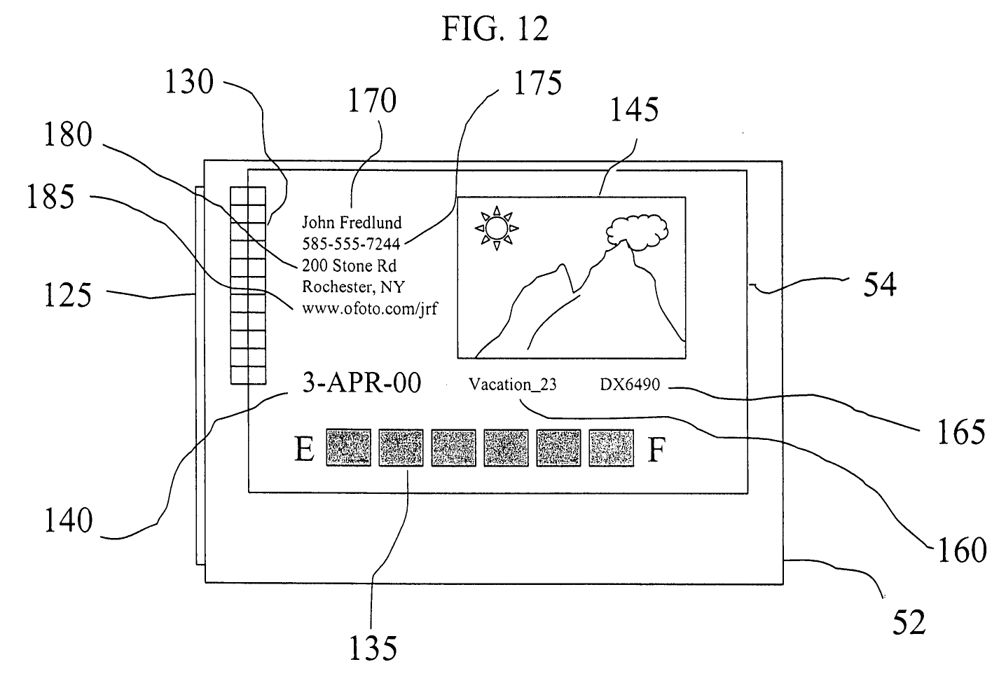

The information shown on a memory display need not be limited to camera or image specific information. FIG. 12 shows information on display 54 on memory card 52 describing the user of memory card 52. This information can include the user's name 170, telephone number 175 and physical address 180. Uniform Resource Locator (URL—the World Wide Web address of a site on the internet) 185 is provided to indicate the web address to which the image has been uploaded. If enough addressable pixels and connections are provided in memory display 54, almost any information of the user's choice can be displayed. This information can include bar codes and other machine readable indicia.

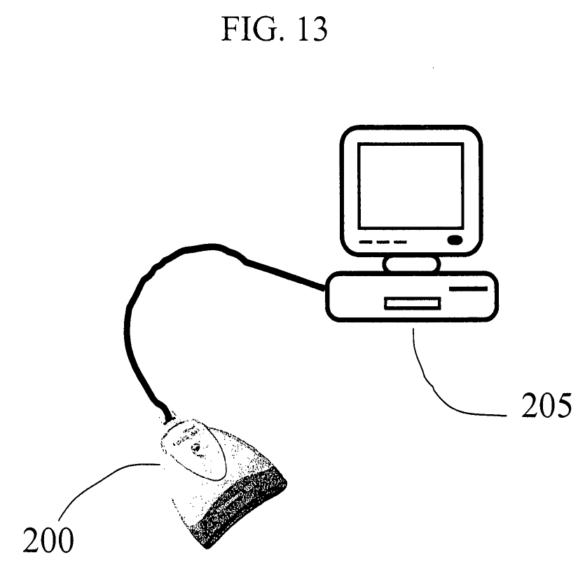

Information can be written to memory display 54 by the camera, as previously described, or by memory card reader/writer 200 in FIG. 13. Memory card reader/writer 200 is connected to computer 205 and is adapted to make contact with connector 125 to transfer image data or other data for storage as is traditional in computer peripherals. Memory card reader/writer 200 is also adapted to make contact with connector 130 so that the high voltages necessary to update memory display 54 can be applied. Unlike camera 12, memory card reader/writer 200 must has no flash circuitry and must provide a source of high voltage.

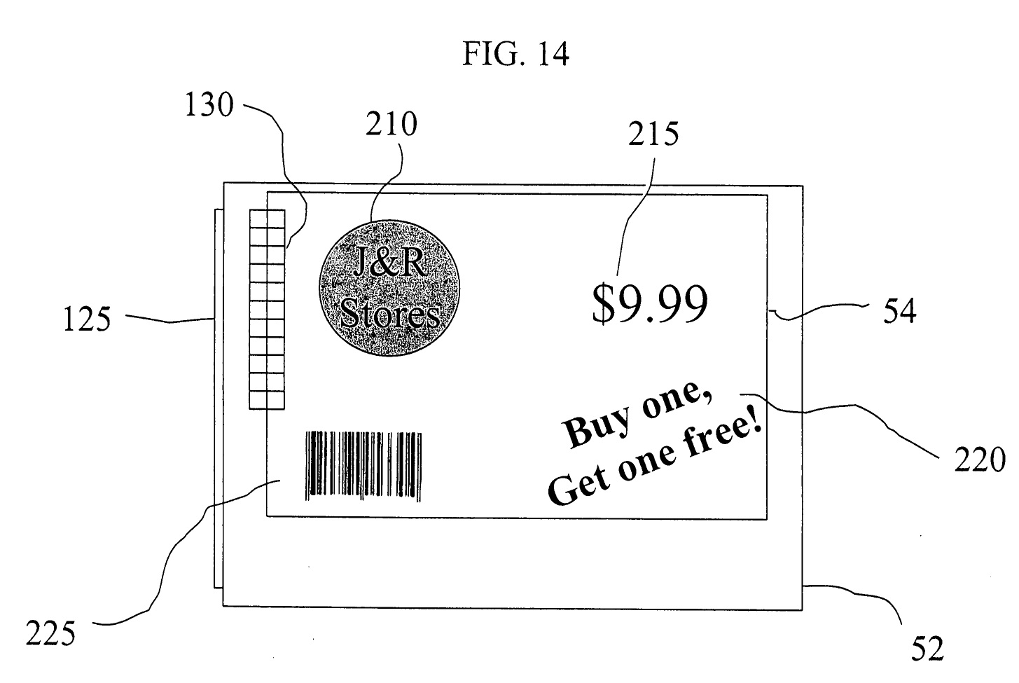

Uses of memory display 54 are not limited to that of the eventual owner. The retailer can specify that the card is delivered with logo 210, price 215, advertising 220 or bar code 225 as shown in FIG. 14. The manufacturer can use memory display 54 to display text 230 that calls out manufacturer-supplied content such as software or imagery that is stored on the card. Instructions for use can be read from memory card 52 by camera 12 or memory card reader/writer 200 and displayed on memory display 54.

When memory card 52 with memory display 54 is used in a camera that is not compatible with writing to memory display 54, the display can be updated at the time memory card 52 is inserted in memory card reader/writer 200. The status of memory card 52 is ascertained by computer 205 running appropriate software, and computer 205 instructs memory card reader/writer to write the appropriate information to memory display 54.

Camera 12 or memory card reader/writer 200 can also write a display control file to memory card 52. This file can be written in an image format such as JPEG so that it is accessible by the camera display or in some other format. The display control file contains information concerning what is to be written to memory display 54. This information can be created by either the user using the interface on camera 12 or by using computer 205 to instruct memory card reader/writer 200 to write appropriate information in the display control file. Camera 12 reads the display control file and writes the appropriate information to memory display 54. The display control file can instruct the camera to write information to memory display 54 such as but not limited to first image captured or most recent image captured or both, date of first image or most recent image captured or both, how many images to show, camera make and model, camera settings, and user name. For uses other than photography, such as for an MP3 player, the display control file can instruct the MP3 player or the memory card reader/writer 200 to display other information such as song titles and song durations.

The invention has been described in detail with particular reference to certain preferred embodiments thereof, but it will be understood that variations and modifications can be effected within the spirit and scope of the invention.

### PARTS LIST

10 conventional camera

12 electronic camera

20 film cassette

22 film

24 take-up spool

26 optic

30 camera controller

35 display

37 memory display

40 flash capacitor

42 flash tube

50 sensor

52 removable memory card

54 memory display

56 adhesive

58 marking

59 self locating feature

60 memory material

61 substrate

62 transparent top conductor

64 bottom conductor

70 reflected light

72 absorbed light

80 reflecting segment

82 transmitting segment

90 voltage regulator

92 high-low voltage select line

94 segment switch

100 row traces

105 column traces

110 pixel

115 row drivers

120 column selector

125 memory card connector

130 memory display connector

135 bar indicator

140 time or date indicator

145 image display area

160 filename display

165 camera type display

170 user's name

175 telephone number

180 physical address

185 Uniform Resource Locator (URL)

200 memory card reader/writer

205 computer

1. A removable data bearing medium having a display which displays images in response to applied voltage and a data containing memory, comprising:
(a) means for coupling the memory to a first source of voltage for retrievably storing data files; and
(b) means disposed in the removable image bearing medium for selectively coupling a voltages to the image bearing medium from a second source of voltage, the image bearing medium including material which is effective in a first condition in response to a selectively applied first voltage for displaying an image and effective in a second condition in response to a second voltage lower than the first voltage to prevent the display of an image, the material being selected so that after displaying the image such material continues to display the image after the removal of the applied voltages from the second source of voltage.

2. The device of claim 1 further including contacts associated with the image bearing medium to permit the electrical connection between the image bearing medium and the second voltage source.

3. The device of claim 1 wherein the memory contains a display control file that controls the information written to the display on the image bearing medium.

4. The device of claim 3 wherein the display control file specifies at least one of the following: telephone number, determination of image displayed, user name, camera type, camera settings, determination of date displayed, number of images displayed, song name, song duration, file name, URL, or instructions for use.

5. The device of claim 1 wherein the image displayed is written at the time of manufacture.

6. The device of claim 5 wherein the image displayed includes at least one of the following: a company logo, price, bar code or advertising.

7. The device of claim 1 wherein the image display is configured so as not to impede the insertion of the image bearing medium into other devices.

8. The device of claim 1 wherein the image display is affixed to the image bearing medium by a user.

9. The device of claim 8 wherein the image display has a self locating feature.

10. The device of claim 1 wherein the second source of voltage does not interfere with operation of a camera.

11. A memory card reader/writer, comprising:
(a) means for coupling a memory card to a first source of voltage for retrievably storing data files; and
(b) means disposed in the memory card reader/writer for selectively coupling a voltages to the image bearing medium from a second source of voltage, the image bearing medium including material which is effective in a first condition in response to a selectively applied first voltage for displaying an image and effective in a second condition in response to a second voltage lower than the first voltage to prevent the display of an image, the material being selected so that after displaying the image such material continues to display the image after the removal of the applied voltages from the second source of voltage.
